(19) United States
(12) Patent Application Publication
(10) Pub. No.: US 2010/0066622 A1
(43) Pub. Date: Mar. 18, 2010

(54) MULTI-SECTOR ANTENNA

(76) Inventors: Julian Thevenard, Laiz (FR); Dominique Lo Hine Tong, Rennes (FR); Ali Louzir, Rennes (FR); Corinne Nicolas, La Chapelle Des Fougeretz (FR); Christian Person, Locmaria Plouzane (FR); Jean-Philippe Coupez, Le Relecq Kerhuon (FR)

Correspondence Address: Robert D. Shedd, Patent Operations;THOMSON Licensing LLC, P.O. Box 5312, Princeton, NJ, 08543-5312, US

(21) Appl. No.: 12/312,797

(22) PCT Filed: Nov. 29, 2007
(86) PCT No.: PCT/FR2007/052419

§ 371 Date: May 27, 2009

(30) Foreign Application Priority Data
Dec. 1, 2006 (FR) 0655246

(51) Int. Cl. H01Q 13/10

(52) U.S. Cl. 343/770

(57) ABSTRACT

The present invention relates to a multi-sector antenna comprising N (N>1) planar antennas each constituted of a longitudinal radiation slot etched on a first substrate provided with a ground plane and supplied by an excitation line. The N first substrates are fixed on a second common substrate so that the radiation axis of each antenna is parallel to said second substrate, the N first substrates being interconnected around an axis perpendicular to the second substrate. The invention can be applied to high definition wireless cameras.

The present invention relates to multi-sector antennas, more specifically a multi sector antenna formed from N planar antennas.

The growing development of communications systems, particularly wireless, requires systems that are more and more complex and effective while maintaining manufacturing costs as low as possible and a minimum size. However in this domain, antennas represent an exception to this miniaturization. In fact, they are subject to physical laws that impose a minimum size for operation at a given frequency. Hence, for printed planar antennas, the dimensions are generally in the order of the wavelength at the central operating frequency. It cannot be denied that the printed planar structures are perfectly adapted for mass production of devices integrating passive and active functions. However as for the radiating elements, a planar structure does not authorize a complete control of antenna radiation, particularly in elevation. Moreover, the directivity and angular opening of the main lobe of the radiation pattern of the antenna are directly linked to the antenna dimensions that must be increased to obtain a high degree of directivity and/or large opening of the main lobe. Hence, multi-sector antennas using a planar structure currently on the market are bulky and costly.

The present invention proposes a three dimensional (3D) multi-sector antenna that reduces the projected size of the antenna while maintaining good radio electrical performance particularly in yield, frequency bandwidth and radiation pattern.

The present invention also proposes a three dimensional (3D) multi-sector antenna that is easy to implement and inexpensive.

The present invention therefore relates to a multi-sector antenna comprising N (N>1) planar antennas each constituted of a longitudinal radiation slot etched on a first substrate featuring a ground plane and supplied by an excitation line, the N first substrates being interconnected about the same axis. In accordance with the invention, the N first substrates are provided on at least one of the substrate sides parallel to the radiation axis of each antenna connection means fixed on a second substrate perpendicular to the N first substrates.

According to a characteristic of the invention, the N first substrates are made of plastics, more particularly materials of the PBT (Polybutylene Terephtalate) class.

Consequently, according to a first embodiment of the invention, each N first substrate is constituted by a plastic plate on which one side is metallized.

In an embodiment of the invention, the N first substrates are connected on a mast perpendicular to the second substrate.

According to another embodiment, two first substrates are realized on a single plate in plastic, one part, preferably one half of the first side and another part, preferably the other half of the second side of the plate, being metallized. Moreover, said plate is provided with means permitting its interconnection with at least one other plate.

According to another characteristic of the invention and according to a first embodiment, the N first substrates present on the side fixed to the second substrate a widened part forming said connection means.

According to another embodiment, the connection means are constituted by pins realized on at least one side of said first substrate. Moreover, the second substrate presents a ground plane connecting to the ground plane of the N first substrates, said plane featuring openings for the passage of excitation lines. When the connection means are constituted by pins, the second substrate comprises holes enabling the interlocking with the first substrates.

According to an embodiment of the invention, longitudinal radiation slot type antennas are “progressive wave” type antennas, particularly progressive opening or Vivaldi type antennas.

A three dimensional multi-sector antenna, particularly a Vivaldi type antenna, authorizes great flexibility in realization. The plastic technology enabling the design of 3D multi-sector antennas that can be directly placed on an electronic card like a CMS (surface mounted component) component.

This type of antenna finds applications in the wireless domain, for example for high definition wireless cameras working with frequency bands from 4.8 to 6 GHz.

Other characteristics and advantages of the present invention will emerge upon reading the following description of different embodiments, this description being made with reference to the drawings attached in the appendix, in which:

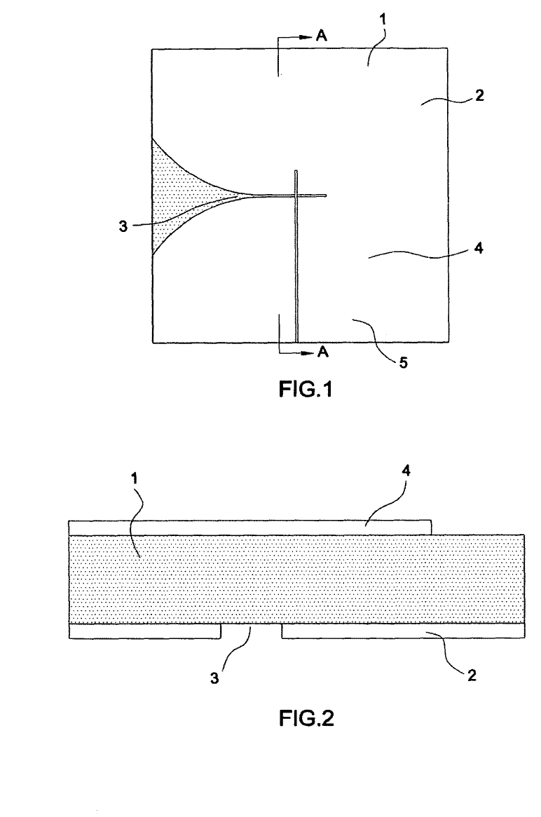

FIG. 1 is a plan representation of a Vivaldi type antenna used in the present invention,

FIG. 2 is an A-A cross-section of FIG. 1,

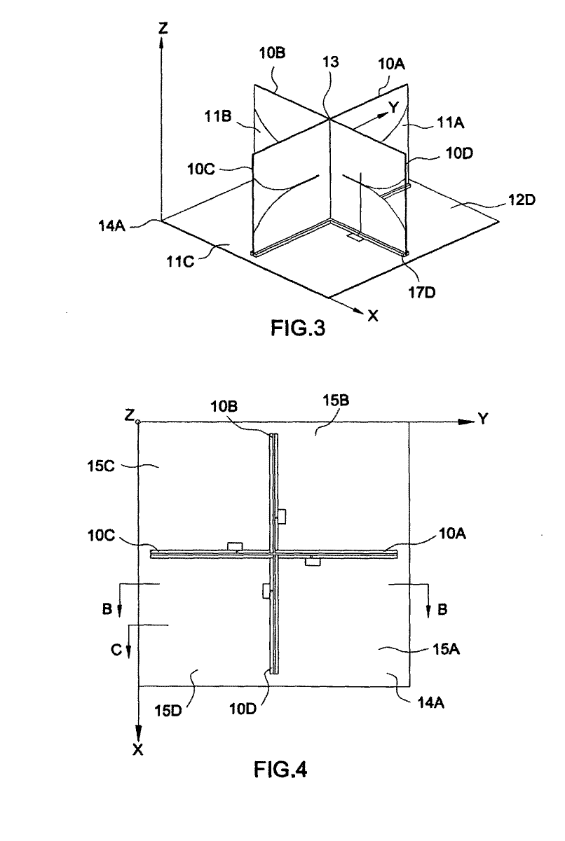

FIG. 3 is a perspective view of a first embodiment of a multi-sector antenna in accordance with the present invention,

FIG. 4 is a top view of the antenna of FIG. 3,

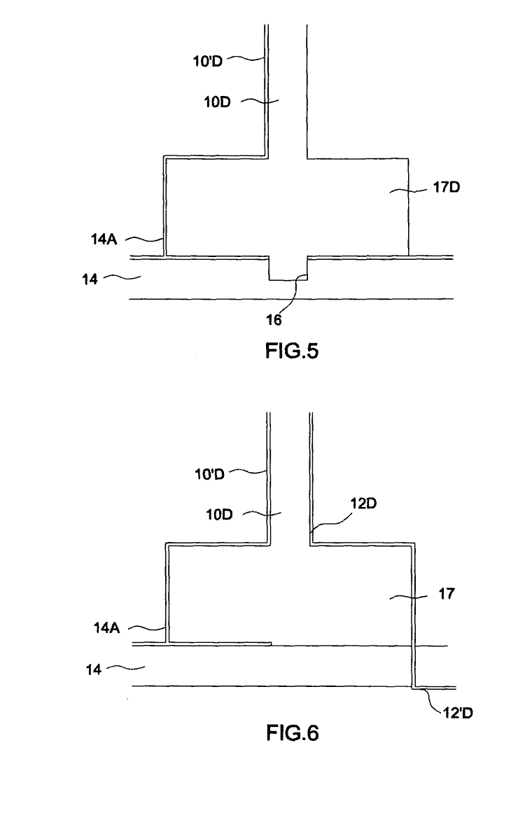

FIG. 5 is a partial B-B cross-section view of FIG. 4,

FIG. 6 is a partial C-C cross-section view of FIG. 4,

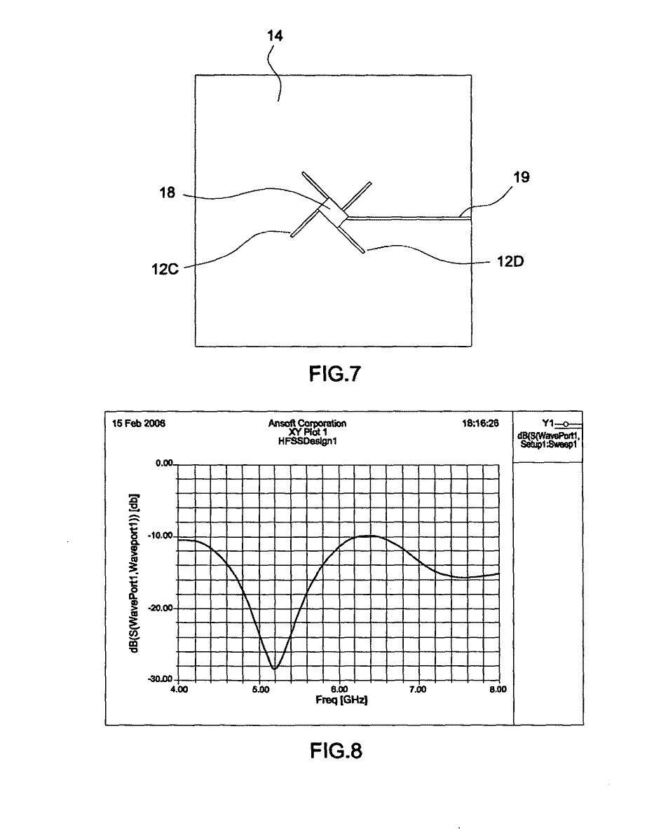

FIG. 7 is an underside view of the antenna of FIG. 3,

FIG. 8 shows a curve giving the reflection losses on one of the antenna accesses of FIG. 3,

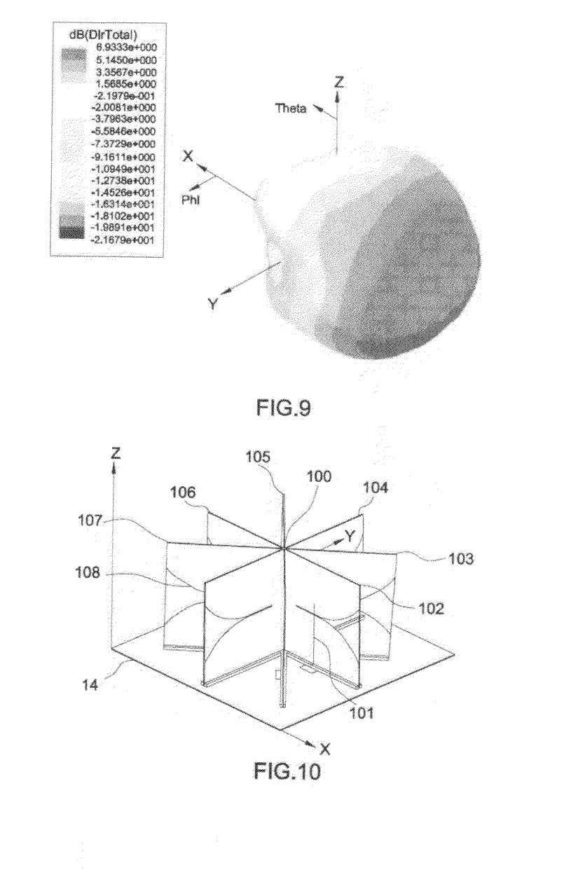

FIG. 9 shows the radiation pattern at 5.5 GHz of a sector of the antenna of FIG. 3,

FIG. 10 is a perspective view of a second embodiment of a multi-sector antenna in accordance with the present invention,

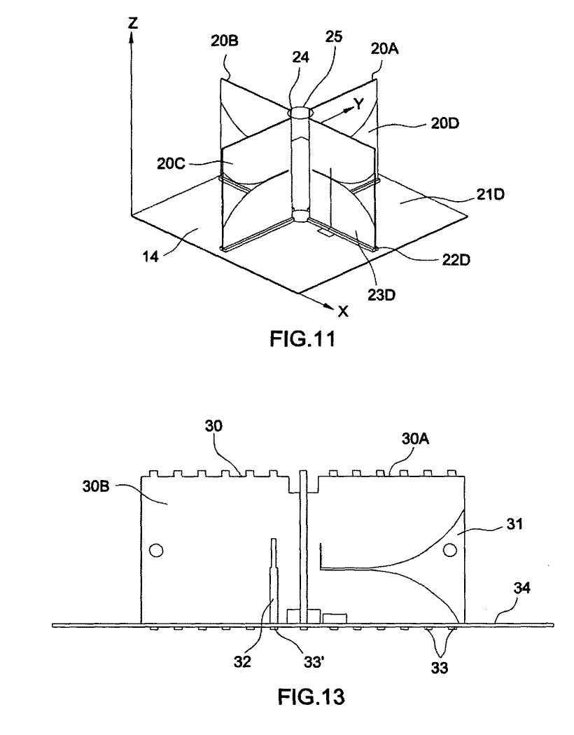

FIG. 11 is a perspective view of a third embodiment of a multi-sector antenna in accordance with the present invention,

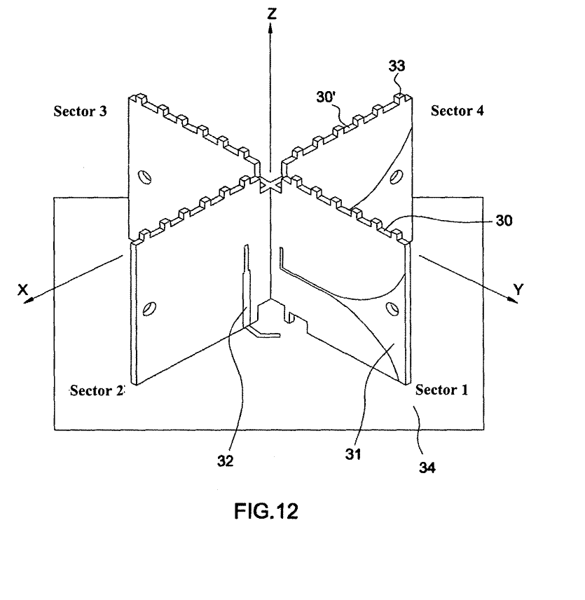

FIG. 12 is a perspective view of a fourth embodiment of a multi-sector antenna in accordance with the present invention, and

FIG. 13 is an elevation view according to a diagonal of the embodiment of FIG. 12.

To simplify the description that follows, the same elements have the same references as the figures.

The present invention will be described in taking for a planar antenna constituted of a longitudinal radiation slot, a Vivaldi type antenna. The tapering of the Vivaldi antenna can have a form that is circular, rectangular, exponential, etc. Other radiating slot planar antenna types can also be possible without leaving the scope of the invention. On FIGS. 1 and 2, is shown a Vivaldi type antenna. This antenna is realized on a dielectric substrate 1 that, in the scope of the invention is constituted of a plastic material such as the PBT (Polybutylene Terephtalate) class plastic materials, for example the material known under the commercial denomination Vestodur (εr=4, tan δ=0.02) or the material known under the commercial denomination POCAN (εr=3.4, tan δ=0.01, h=1.5 mm). The substrate 1 is covered on one side with a conducting material such as a metal forming a ground plane 2, specifically in copper. In the ground plane 2 is etched a slot line 3 which progressively widens to the edge of the substrate. On the other side of the substrate is etched a microstrip line 4 for excitation by electromagnetic coupling of the slot. Other types of supply line are possible without leaving the scope of the present invention, specifically a supply by co-planar line. As shown in FIG. 1, the excitation line 4 is extended to one edge of substrate 1, to obtain an access point 5.

A description will now be given, with reference to FIGS. 3 to 9, of a first embodiment of a multi-sector antenna in accordance with the invention. As shown in FIG. 3, the antenna is constituted of four Vovaldi antennas 10A, 10B, 10C, 10D. These four antennas are each realized on a first substrate as described above, mounted on a second common substrate 14, featured on the upper side of a conducting layer forming a ground plane 14A. More specifically, the four substrates carrying the Vivaldi antennas are fixed on the substrate 14 in such a way that the radiation axis of the Vivaldi slot 11A, 11B, 11C and 11D is parallel to the plane 14A of the second substrate 14. The four first substrates are positioned in parallel with the edges of substrate 14. However the four first substrates can also be positioned according to the diagonals of the second substrate 14, which reduces the size. To facilitate the fixation of Vivaldi antennas, in a first embodiment, the substrate of each Vivaldi antenna presents on the fixation side on the common substrate 14, a widened part such as 17D on FIGS. 3, 5 and 6. This widened part enables connection, for example by solder, on the second substrate 14 and hence ensures an excellent continuity of the ground as shown in FIG. 5, by the references 10′D and 14A. However, depending on the plastic material selected, the solder connection is not recommended. In this case, the widened parts of the first substrates comprise fixation pins that are inserted in specific openings in the second substrate. The pin positioned in the prolongation of the excitation line is a conductor and is inserted in a metallized opening in such a way to obtain an electrical continuity. In addition, this widened part can comprise positioning zones or gauges 16 enabling improved mechanical precision of the connection. The four Vivaldi antennas are interconnected according to an axis 13 perpendicular to the plane of the second substrate 14. In the embodiment shown, the four substrates are mutually perpendicular to form a four-sectors antenna. Each substrate is entirely metallized then etched to realize on one side, the radiation slot, as in 11A, 11B, 11C and 11D and on the other side the excitation line, as in 12D. As shown in FIG. 4, the non-metallized zones 15A, 15B, 15C and 15D are provided in the ground plane 14A of the second substrate for the passage of excitation lines. As shown in FIG. 6 by 12D, the excitation lines are provided along the contour of the widened part of the first substrates receiving the Vivaldi antennas and are connected to a switch circuit referenced as 18 on FIG. 7. Hence the lower plane of the second dielectric substrate 14 comprises a switching circuit 18 that can be constituted of components such as PIN diodes, MEMs or other switching components connected to excitation lines 12A, 12B, 12C and 12D of Vivaldi antennas and to the common supply line 19.

A multi-sector antenna of this type was simulated with the electromagnetic simulation application HFSS based on the finished elements method of the ANSOFT corporation using the following values:

Operating frequency 5.5 GHz.

First substrate: plastic material having a permitivity of 3.5 and a loss tangent of 0.01. The substrate has a thickness of 0.77 mm.

Second substrate: Rogers 4003 type having a permitivity of 3.38 and a loss tangent of 0.0027 and having a thickness of 0.81 mm.

The results of the simulation are provided in FIGS. 8 and 9. FIG. 8 gives the reflection losses in one of 4 accesses to a Vivaldi antenna. In this case, the adaptation remains wide band around the operating frequency 5.5 GHZ. The directivity value for a single lit-up sector, the three others being deactivated, is 6.9 dBi. The radiation pattern shown in FIG. 9 remains in accordance with the radiation pattern of a Vivaldi antenna placed in an environment without restrictions.

Now is described with reference to FIG. 10, another embodiment of the present invention. In this case the mult-sector antenna comprises eight Vivaldi type antennas 101, 102, 103, 104, 105, 106, 107, 108 interconnected at the level of a common axis 100 perpendicular to a common substrate 14. Each Vivaldi type antenna is identical to the Vivaldi type antennas described above. The maximum number N of Vivaldi type antennas that can be interconnected to determine the sectors is determined by physical laws.

With reference to FIG. 11, a third embodiment of the present invention will now be described. In this embodiment, the four Vivaldi type antennas 20A, 20B, 20C and 20D are connected on a mast 24 with a groove 25 in which is inserted one side of the substrate of the Vivaldi antenna. The mast 24 is fixed perpendicularly to the second substrate 14. In the embodiment the Vivaldi type antennas are realized independently by the usual techniques of circuit metallization.

Certain improvements can be applied to the embodiments described above. For example, the mast can comprise additional positioning pins or be hollowed out in its lower part to be able to integrate components on a common substrate.

A fourth embodiment of the present invention will now be described with reference to FIGS. 12 and 13. In this embodiment, on a rectangular plate 30 in plastic such as that mentioned above, two first substrates 30A and 30B were realized. To do this, a first half side of the rectangular plate is metallized and in this metallized side is etched a tapered slot 31, the non-metallized half side receiving a microstrip line 32.

On the other side of the plate, the metallization is reversed. This structure provides two Vivaldi antennas. The rectangular plate 30 has in its middle a slot enabling interlacing with another rectangular plate 30′ of the same type as shown in FIG. 12.

In compliance with the present invention and as shown in FIGS. 12 and 13, the rectangular plate presents at least on one of its lengths, pins 33 with one of the pins 33′ extending the microstrip line 32. The pins 33 enable fixation of different rectangular plates 30, 30′ on the second substrate 34 provided with corresponding openings.

Preferably, the hole corresponding to pin 33′ receiving the microstrip excitation line 32 is metallized. The other pins 33 being metallized, it ensures a ground continuity with the second substrate 34 whose top side is metallized. As for the preceding embodiments, the lower side of the substrate receives the microstrip lines connecting the excitation lines of the Vivaldi antennas at a common supply line by the intermediary of any adequate circuit.

This embodiment is simple and cheap to realize. It requires no soldering and the elements constituting the multi-sector antenna can be standardized.

The multi-sector antenna compliant with the present invention leads to an augmentation in directivity and a reduction in the beam width to cover a given sector using a three dimensional device.

This antenna has the following advantages:

a. Conservation of good performance in terms of gain and beam width while conserving reduced size.

b. Possibility of obtaining a greater number of sectors than with planar technology.

c. Diversification of form factors due to the addition of the third dimension.

d. Flexibility in design, construction and integration due to the “metallized plastic” technology that permits complex and varied forms.

1 - Multi-sector antenna comprising N (N>1) planar antennas each constituted of a longitudinal radiation slot etched on a first substrate provided with a ground plane and supplied by an excitation line, the first substrates being interconnected according to a single axis, wherein the N first substrates have on at least one side of the substrate parallel to the axis, connection means fixed on a second substrate perpendicular to the N first substrates.

2 - Antenna according to claim 1, wherein the excitation line is constituted by a line printed on the side of the first substrate opposite the side receiving the slot.

3 - Antenna according to claim 1, wherein the first substrates are constituted by a plate made of plastic material.

4 - Antenna according to claim 3, wherein each N first substrate is constituted by a plate made of plastic of which one side is metallized.

5 - Antenna according to claim 4, wherein the N first substrates are connected on a mast perpendicular to the second substrate.

6 - Antenna according to claim 3, wherein two first substrates are formed by a single plate in plastic material, one part of the first side and another part of the second side of the plate being metallized.

7 - Antenna according to claim 1, wherein the first substrates present on the fixed side on the second substrate a widened part.

8 - Antenna according to claim 1, wherein the connection means are constituted by pins realized on at least one side of a first substrate.

9 - Antenna according to claim 1, wherein the second substrate presents a ground plane connecting to the ground plane of the first substrates, said plane being provided with openings for the passage of excitation lines and/or pins.

10 - Antenna according to claim 1, wherein the N excitation lines of the planar antennas are connected through a switching circuit to a common supply line.

11 - Antenna according to claim 10, wherein the supply line is a printed line realized on the second substrate.
